(19) United States
(12) Patent Application Publication
(10) Pub. No.: US 2021/0051961 A1
(43) Pub. Date: Feb. 25, 2021

(54) METALLIC OXIDE/SILICATE CLAY NANO-COMPOSITE AND METHOD FOR PRODUCING THE SAME

(71) Applicants: Jiang-Jen Lin, Taipei (TW); J & V Consultant Corporation, Taipei (TW)

(72) Inventors: Jiang-Jen Lin, Taipei (TW); Shui-Fa Hou, Taipei (TW); Sheng-Yen Shen, Taipei (TW); Fang-Yi Ye, Taipei (TW); Ting-Yueh Hou, Taipei (TW); Chun-Fan Chen, Taipei (TW); Yi-Chen Lee, Taipei (TW)

(21) Appl. No.: 16/876,081

(22) Filed: May 17, 2020

(30) Foreign Application Priority Data
Aug. 22, 2019 (TW) 108130097

(51) Int. Cl. A01N 59/16; A01N 25/08; A23K 20/28; A23K 20/20; A23K 10/30; A23K 40/10

(52) U.S. Cl. CPC A01N 59/16; A01N 25/08; A23K 40/10; A23K 20/30; A23K 10/30; A23K 20/28

(57) ABSTRACT

Metallic oxides nanoparticles are stably adsorbed on silicate clay (such as nanosilicate platelets, NSPs) to form the metallic oxide/silicate clay nano-composite. The metallic oxides nanoparticles may be ZnO, CuO, Fe₃O₄, MgO or CaO. Optionally, silver nanoparticles are also adsorbed on the silicate clay for applications. Different from polymer dispersants, the silicate clay has high surface area and charge density so that the metallic oxides are not wrapped and thus perform better bactericidal efficacies.

### BACKGROUND OF THE INVENTION

### (a) Field of the Invention

The field of this invention relates to metallic oxide/silicate clay nano-composites, methods for producing them, and their uses.

### (b) Description of the Prior Art

Many metallic oxide nanoparticles have bactericidal efficacies and therefore are widely applied to antibacterial agents. For example, zinc oxide (ZnO) being nontoxic to microorganisms and biocompatible to human cells has been researched. Copper oxide (CuO) is another example as it is less costly and more friendly to the environment than silver (Ag). In the known processes, organic stabilizers are usually used to prevent the metallic oxide nanoparticles from self-aggregation. As a result, the metallic oxide nanoparticles are overly wrapped by the organic stabilizer and thus surface activities thereof are reduced and the antibacterial efficacy can't be achieved.

In order to solve the above problem, silicate clay such as the nanosilicate platelets (NSPs) is selected to support the metallic oxide. The silicate clay possesses specific surface characteristics that enable the metallic oxide nanoparticles to be uniformly dispersed without being wrapped.

### BRIEF SUMMARY OF THE INVENTION

A metallic oxide/silicate clay nano-composite and a method for producing the same are described. The metallic oxide/silicate clay nano-composite includes silicate clay and metallic oxide nanoparticles. The silicate clay is selected from nanosilicate platelets (NSPs), montomorillonite (Na⁺-MMT), fluoro mica, K10, SWN, kaolin, talc, attapulgite and vermiculite. The NSPs are fully exfoliated silicate clay, have a diameter-to-thickness ratio ranging from 100×100×1 nm³ to 500×500×1 nm³ and have a cation exchange capacity (CEC) ranging from 1.0 mequiv/g to 1.5 mequiv/g. The metallic oxide nanoparticles are selected from ZnO, Fe₃O₄, CuO, MgO and CaO and uniformly stabilized on surfaces of the silicate clay by ionic bonds and Van der Waals forces. The metallic oxide nanoparticles and the silicate clay have a weight ratio ranging from 1/99 to 90/10.

The silicate clay is preferably the nanosilicate platelets (NSPs). The metallic oxide is preferably ZnO or CuO, and more preferably ZnO. The metallic oxide nanoparticles and the silicate clay preferably have a weight ratio ranging from 1/99 to 70/30. The metallic oxide/silicate clay nano-composite may further include silver nanoparticles stabilized on surfaces of the silicate clay by ionic bonds and Van der Waals forces.

The method for producing a metallic oxide/silicate clay nano-composite includes steps of: (1) adding a water solution of a metallic salt into a dispersion of silicate clay to perform an ion-exchange reaction; (2) adding a proper hydroxide to react with the metallic salt to form a metallic hydroxide on surfaces of the silicate clay; and (3) dehydrogenating the metallic hydroxide at 40° C.-99° C. to form a metallic oxide stabilized on the surfaces of the silicate clay as a product, the metallic oxide/silicate clay nano-composite. The metallic salt is a salt of Zn, Fe, Cu, Mg or Ca. The silicate clay is defined as the above. The metallic salt and the silicate clay are added in proper amounts to yield a metallic oxide/silicate clay nano-composite that has a weight ratio ranging from 1/99 to 90/10.

The silicate clay of step (1) is preferably nanosilicate platelets (NSPs). The metal of step (1) is preferably Zn or Cu, and more preferably ZnO. The metallic salt of step (1) is preferably a metallic acetate, a metallic carbonate or a metallic chloride. The ion-exchange reaction of step (1) is preferably performed at 40° C.-99° C. The proper hydroxide of step (2) is preferably NaOH or NH₄OH. The product of step (3) is preferably further filtered to obtain the metallic oxide/silicate clay nano-composite in the form of powder. The method can further include step (4) adding a compound of silver ions and a proper reducing agent to reduce the silver ions to silver nanoparticles stabilized on the surfaces of the silicate clay. The reducing agent is preferably NaBH₄.

A modified livestock feed including a livestock feed and a metallic oxide/silicate clay nano-composite attached to the livestock feed is further described. The metallic oxide/silicate clay nano-composite is defined as the above.

The livestock feed is selected from modified starch, corn flour, sweet potato starch, water-soluble starch, high-fructose corn syrup (HFCS), mung bean starch, wheat starch, glucosan, soybean powder, cyclodextrin, maltodextrin, carboxymethyl cellulose (CMC), cellulose, gum arabic, carrageenan, xanthan gum, alginate, trehalose, rice bran, gluten, corn bran or polyethylene glycol (PEG). The silicate clay is preferably nanosilicate platelets (NSPs) and the metallic oxide is preferably ZnO or CuO, and more preferably ZnO. The metallic oxide/silicate clay nano-composite is preferably attached to the livestock feed by spray drying.

### BRIEF DESCRIPTION OF THE DRAWINGS

FIG. 1 illustrates the general procedure for producing the nano-composite of the present invention.

FIGS. 2A, 2B and 2C respectively show the UV-visible spectra, the XRD spectra and the TEM image of the ZnO/NSP nano-composite.

FIG. 2D shows the particle length distribution of ZnO of the ZnO/NSP nano-composite.

FIGS. 3A, 3B and 3C respectively show the UV-visible spectra, XRD spectra and the TEM image of the CuO/NSP nano-composite.

FIG. 3D shows the particle length distribution of CuO of the CuO/NSP nano-composite.

FIGS. 4A and 4B respectively show the UV-Visible spectra and the TEM spectra of the Ag/ZnO/NSP nano-composite.

FIG. 4C shows the particle length distribution of Ag/ZnO of the Ag/ZnO/NSP nano-composite.

### DETAILED DESCRIPTION OF THE INVENTION

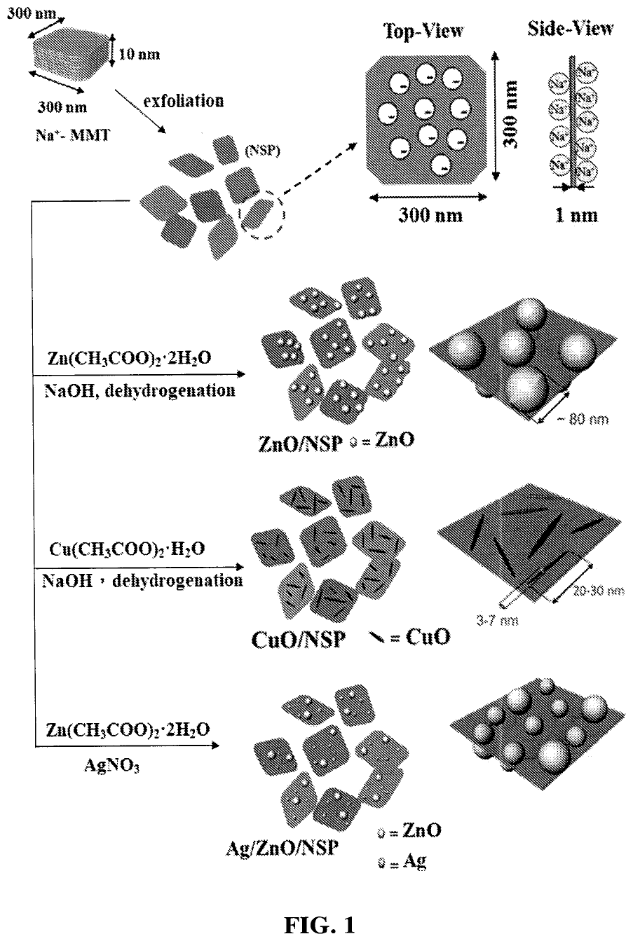

FIG. 1 illustrates the general procedure for producing the metallic oxide/silicate clay nano-composite of the present invention. First, montmorillonite (Na⁺-MMT) is fully exfoliated to form the nanosilicate platelets (NSPs). Then let Zn(CH₃COO)₂·2H₂O or Cu(CH₃COO)₂·H₂O react with NaOH in the presence of the NSPs to form the ZnO/NSP or CuO/NSP nano-composite. The ZnO/NSP nano-composite can further react with AgNO₃ to form the Ag/ZnO/NSP nano-composite. The ZnO, CuO and Ag nanoparticles can all be uniformly stabilized on surfaces of the NSPs. The detailed procedures are described as follows.

### 1. Preparing the Nanosilicate Platelets (NSPs)

The NSPs can be commercial products or prepared according to methods described in, for example, U.S. Pat. Nos. 7,022,299, 7,094,815, 7,125,916, 7,442,728, 8,168,698, TW Patent No. 593480, TW Patent No. 1280261 and TW Patent No. 1270529. In one of the methods, a proper exfoliating agent is acidified and then reacted with a layered silicate clay, for example, montmorillonite (Na⁺-MMT) to fully exfoliate the layered silicate clay as individual platelets. The platelets can be separated and purified in a two-phase solvent system to obtain the nanosilicate platelets (NSPs). The exfoliating agent may be amine-terminated BPA epoxy oligomer (AEO) synthesized by a salt of amine-terminated polyether and diglycidyl ether of bisphenol-A (DGEBA), amine terminal-Mannich oligomer (AMO) synthesized by a salt of amine-terminated polyether and p-cresol/formaldehyde, or a polymer composite synthesized by a salt of amine-terminated polyether and polypropylene-graft-maleic anhydride (PPgMA).

The NSPs have a high diameter-to-thickness ratio about 300×300×1 nm³ and a cation exchange capacity (CEC) about 1.20 mequiv/g and may be uniformly dispersed in water.

### 2. Synthesizing the ZnO/NSP Nano-Composite

A mechanical stirrer, a reflux condenser and a heating mantle are installed to a three-necked flask through which nitrogen passes. Then a NSP dispersion (207.1 g, 1.2 wt %) is added into the flask and stirred at 500 rpm for 0.5 hour.

Then a water solution of Zn(CH₃COO)₂.2H₂O (24.3 g, 5.0 wt %) is added to the NSP dispersion to perform the ion-exchange reaction at 90° C. for 0.5 hour.

Then a water solution of NaOH (66 g, 1.0 wt %) is dropwise added into the flask to form Zn(OH)₂ on surfaces of the NSPs. The nitrogen is delivered through the flask at 80° C. for 1 hour to dehydrogenate Zn(OH)₂ to ZnO. The solution is then filtered and the solid is washed with deionized water to obtain powders of the ZnO/NSP nano-composite having a weight ratio of 15/85 (w/w=15/85).

The above procedure is repeated to produce the ZnO/NSP nano-composites (w/w=7/93 and 30/70) by adding the reactants of different amounts. The ZnO/NSP nano-composites (w/w=7/93, 15/85 and 30/70) are then analyzed with UV-vis spectrophotometer, x-ray powder diffractometer (XRD) and the transmission electron microscope (TEM).

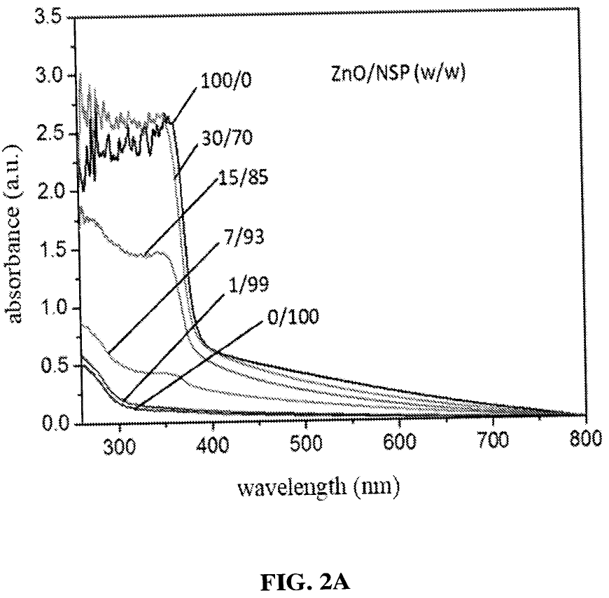

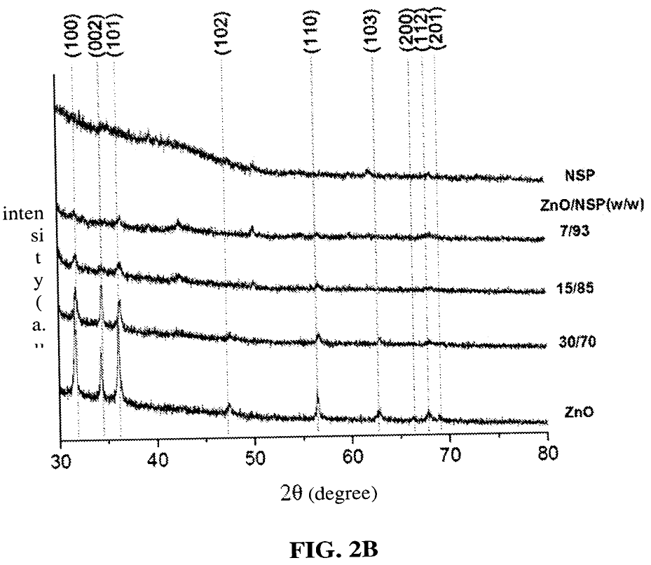

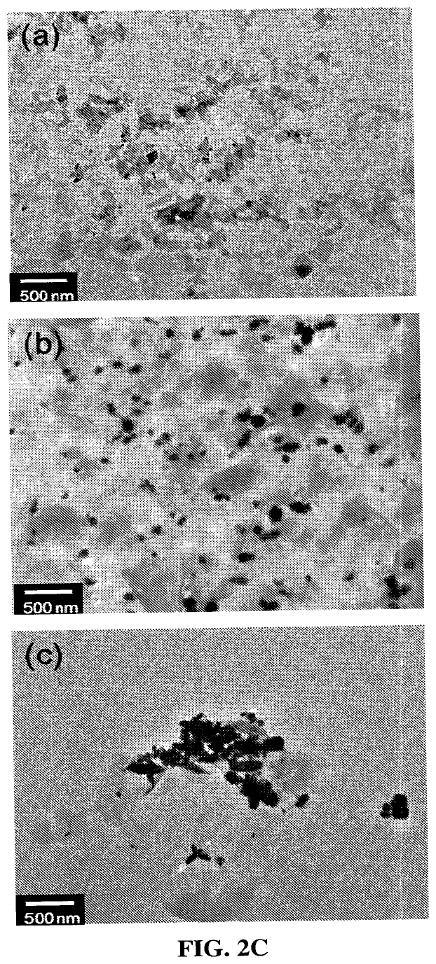

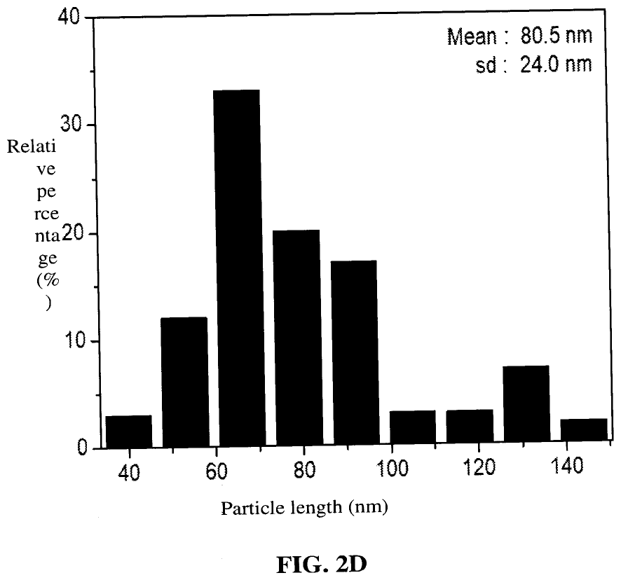

FIG. 2A shows the UV-visible spectra of these ZnO/NSP nano-composites having a solid content of 0.1 wt % in water, and the absorbance peaks at a wavelength of 380 nm increase with the weight ratios of the ZnO/NSP nano-composites.

FIG. 2B shows the XRD spectra. Compared with the data of Joint Committee on Powder Diffraction Standards (JCPDS: 89-0510), the spectra of ZnO formed on the NSPs is the same as the pristine ZnO.

FIG. 2C shows the TEM images wherein patterns (a) and (b) (w/w=7/93 and 15/85) indicate more uniform distribution on surfaces of the NSPs than pattern (c) (w/w=30/70). As a result, the NSPs are suitable for supporting ZnO as carriers thereof.

FIG. 2D shows the particle length distribution of ZnO of the ZnO/NSP nano-composite (w/w=15/85) and the mean length is 80.5±24.0 nm.

### 3. Synthesizing the CuO/NSP Nano-Composite

A mechanical stirrer, a reflux condenser and a heating mantle are installed to a three-necked flask through which nitrogen passes. Then a NSP dispersion (229.5 g, 1.1 wt %) is added into the flask and stirred at 500 rpm for 0.5 hour.

Then a water solution of Cu (CH₃COO)₂H₂O (22.6 g, 5.0 wt %) is added to the NSP dispersion to perform the ion-exchange reaction at 80° C. for 0.5 hour.

Then a water solution of NaOH (45 g, 1.0 wt %) is dropwise added into the flask to form Cu(OH)₂ on surfaces of the NSPs. The nitrogen is delivered through the flask at 80° C. for 1 hour to dehydrogenate blue-green Cu(OH)₂ to dark-brown CuO. The solution is then filtered and the solid is washed with deionized water to obtain powders of the CuO/NSP nano-composite having a weight ratio of 15/85 (w/w=15/85).

The above procedure is repeated to produce the CuO/NSP nano-composites (w/w=7/93 and 30/70) by adding the reactants of different amounts. The ZnO/NSP nano-composites (w/w=7/93, 15/85 and 30/70) are then analyzed with UV-vis spectrophotometer, x-ray powder diffractometer (XRD) and the transmission electron microscope (TEM).

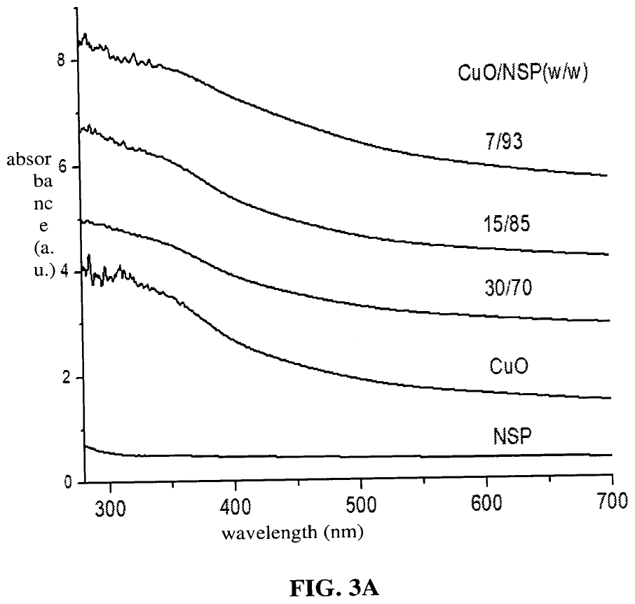

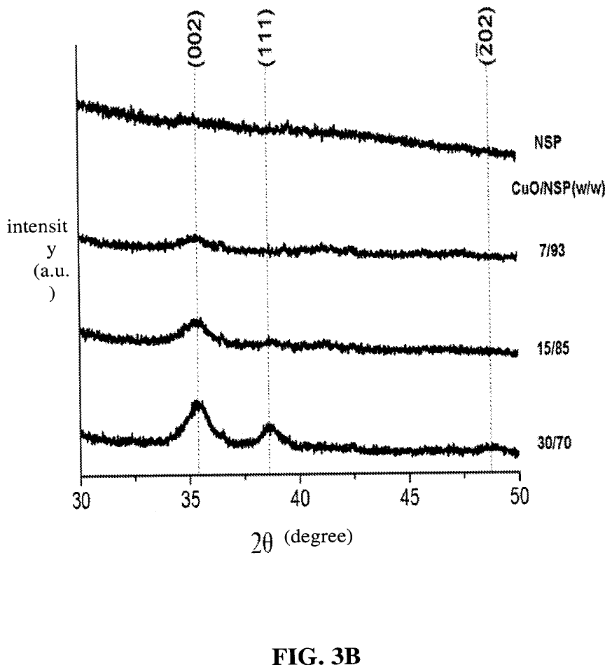

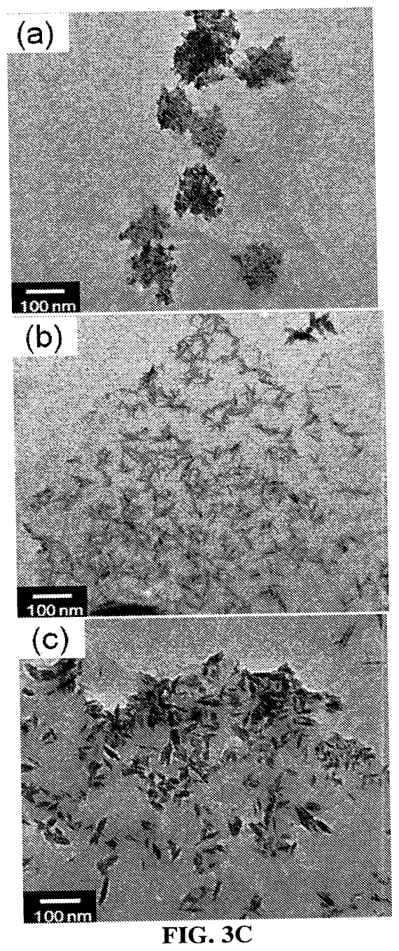

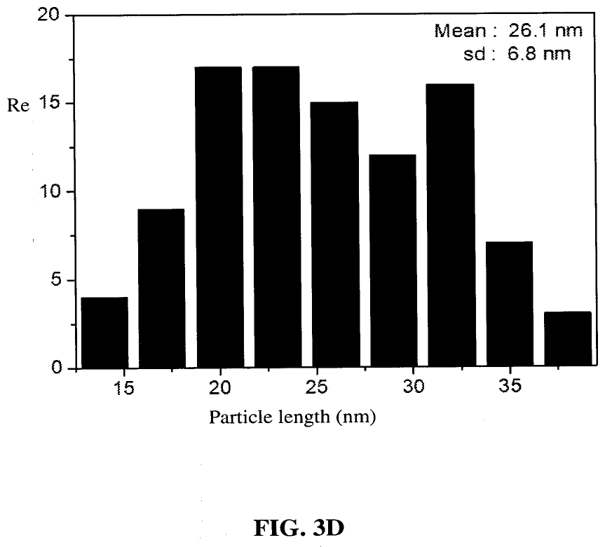

FIG. 3A shows the UV-visible spectra of these CuO/NSP nano-composites and the absorbance peaks of CuO formed on the NSPs are the same as the pristine CuO.

FIG. 3B shows the XRD spectra. Compared with the data of Joint Committee on Powder Diffraction Standards (JCPDS: 05-0661), the spectra of CuO formed on the NSPs is the same as the pristine CuO.

FIG. 3C shows the TEM images and all patterns (a), (b) and (c) indicate that CuO can be uniformly stabilized on surfaces of the NSPs without self-aggregation.

FIG. 3D shows the particle length distribution of ZnO of the ZnO/NSP nano-composite (w/w=15/85) and the mean length is 26.1±6.8 nm.

### 4. Synthesizing the Ag/ZnO/NSP Nano-Composite

A mechanical stirrer, a reflux condenser and a heating mantle are installed to a three-necked flask through which nitrogen passes. Then a NSP dispersion (60 g, 5 wt %) is added into the flask and stirred at 500 rpm for 0.5 hour.

Then a water solution of Zn(CH₃COO)₂.2H₂O (8.09 g, 5.0 wt %) is added to the NSP dispersion to perform the ion-exchange reaction at 90° C. for 0.5 hour.

Then a water solution of NaOH (21 g, 1.0 wt %) is dropwise added into the flask to form Zn(OH)₂ on surfaces of the NSPs. The nitrogen is delivered through the flask at 80° C. for 1 hour to dehydrogenate Zn(OH)₂ to ZnO. The solution is then filtered and the solid is washed with deionized water to obtain powders of the ZnO/NSP nano-composite having a weight ratio of 5/99 (w/w=5/99).

A water solution of the ZnO/NSP nano-composite (100 g, 2.0 wt %) is added into a round-bottom flask with mechanical stirring at 500 rpm for 0.5 hr. A water solution of AgNO₃ (3.1 g, 1.0 wt %) and then a water solution of a reducing agent, NaBH₄ (0.3 g, 1.0 wt %) are added into the flask with mechanical stirring for 1 hr. The silver ions (Ag⁺) are reduced to silver (Ag⁰) when the solution becomes brown color from yellow color and the Ag/ZnO/NSP nano-composite (w/w/w/=1/5/99) in the form of powder is produced.

The above procedure is repeated to produce the Ag/ZnO/NSP nano-composites (w/w/w=1/10/99) by adding the reactants of different amounts. The Ag/ZnO/NSP nano-composites (w/w/w=0/1/99, 1/5/99 and 1/10/99) are then analyzed with UV-vis spectrophotometer and x-ray powder diffractometer (XRD).

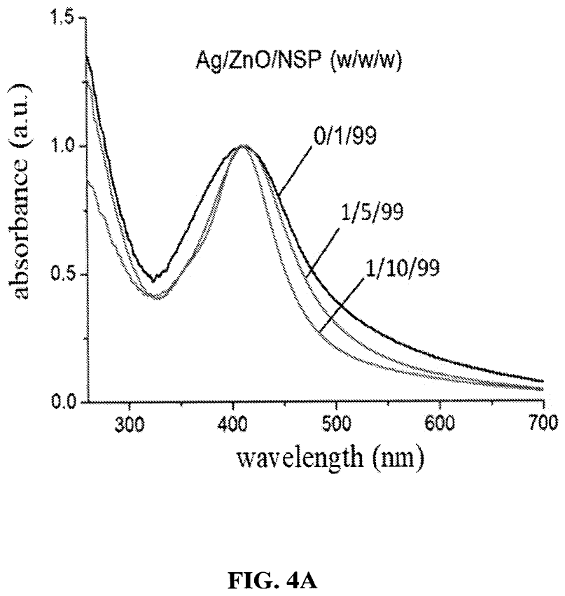

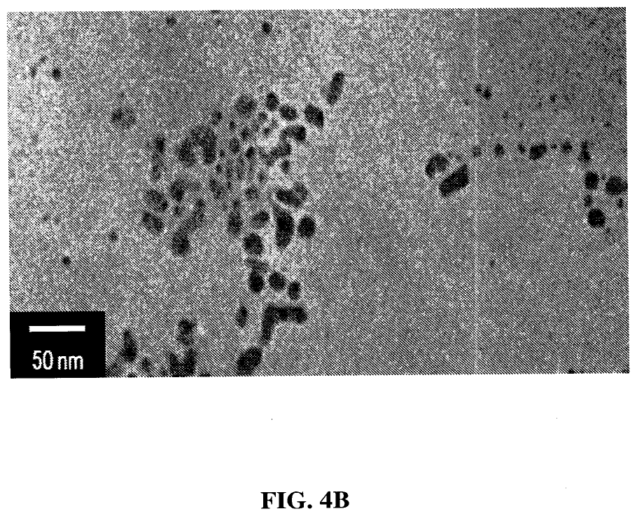

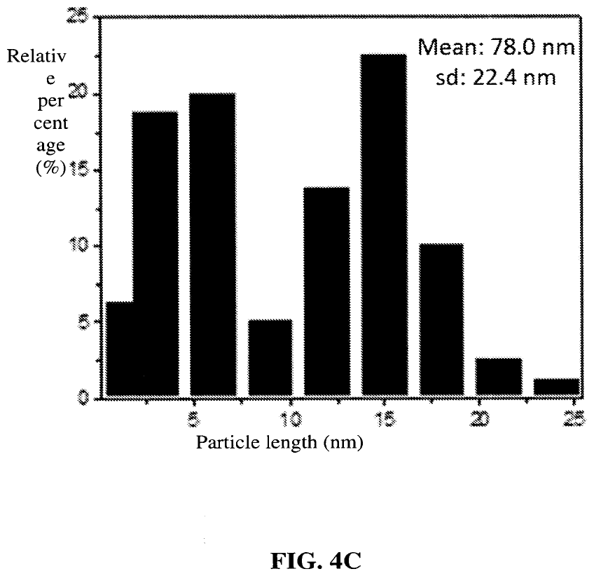

FIG. 4A shows the UV-visible spectra of the Ag/ZnO/NSP nano-composites (w/w/w=0/1/99, 1/5/99 and 1/10/99) and the absorbance peaks are respectively observed at wavelengths 409 nm, 414 nm and 409 nm. That is, the Ag nanoparticles formed on the NSPs is not influenced by the ZnO nanoparticles.

FIG. 4B shows the TEM image of the Ag/ZnO/NSP nano-composite (w/w/w=1/10/99) and most of the Ag nanoparticles and ZnO nanoparticles are uniformly stabilized on surfaces of the NSPs without self-aggregation.

FIG. 4C shows the particle length distribution of Ag/ZnO of the Ag/ZnO/NSP nano-composite (w/w/w=1/10/99) and the mean length is 78.0±22.4 nm.

### 5. Antibacterial Testing

The antibacterial testing are performed according to National Committee for Clinical Laboratory Standards.

### (1) Antibacterial Efficacies of the ZnO/NSP Nano-Composite and the NSPs

Water solutions of the ZnO/NSP nano-composite (w/w=30/70), NSP/corn flour (w/w=1/1) and (ZnO/NSP)/(NSP/corn flour)/corn flour (w/w/w=5/10/85) are brought to the antibacterial tests against E. coli (1×10⁶ CFU/mL). NSP/corn flour is a mixture of NSPs and corn flour. (ZnO/NSP)/(NSP/corn flour)/corn flour is a mixture of ZnO/NSP (w/w=30/70), NSP/corn flour (w/w=1/1) and corn flour. TABLE 1 shows the testing results.

TABLE 1

| | | Colony count | Colony count |
|---|---|---|---|
| Samples | Concentrations | (3 hrs) | (6 hrs) |
| Control group | — | 92 | 118 |
| ZnO/NSP | 50 ppm (ZnO) | 3 | 5 |
| ZnO/NSP | 70 ppm (ZnO) | 0 | 0 |
| NSP/corn flour | 100 ppm (NSP) | 10 | 17 |
| NSP/corn flour | 250 ppm (NSP) | 8 | 15 |
| (ZnO/NSP)/(NSP/corn | 50 ppm (ZnO), | 0 | 0 |
| flour)/corn flour | 100 ppm (NSP) | | |

The bactericidal efficacies of the ZnO/NSP nano-composite (50 ppm), NSP/corn flour (100 ppm and 250 ppm) are not as good as that of the ZnO/NSP nano-composite (70 ppm). However, the bactericidal efficacy of the NSP/corn flour (100 ppm) associated with the ZnO/NSP nano-composite (50 ppm) is excellent. In other words, the ZnO/NSP nano-composite can greatly promote the antibacterial efficacies of the NSP/corn flour.

### (2) Antibacterial Efficacies of the ZnO Nano-Particles, the ZnO/NSP Nano-Composite and the Ag/ZnO/NSP Nano-Composite

The water solutions of the ZnO nano-particles, the ZnO/NSP nano-composite (w/w=15/85) and the Ag/ZnO/NSP nano-composite (w/w/w=1/10/99) are brought to the antibacterial tests against E. coli (1×10⁸ CFU/mL).

TABLE 2

| Samples | Weight ratio | MBC (ppm, ZnO) |
|---|---|---|
| ZnO | — | 3000 |
| ZnO/NSP | 15/85 | 920 |
| Ag/ZnO/NSP | 1/10/99 | 10 |

TABLE 2 shows that the bactericidal efficacy of the ZnO nano-particles is obviously improved by NSP as self-aggregation can be prevented when they are uniformly distributed on surfaces of the NSPs. The bactericidal efficacy of the ZnO/NSP nano-particles is further improved by Ag nano-particles.

### (3) Antibacterial Efficacies of the ZnO/NSP Nano-Composite, the Ag/NSP Nano-Composite and the Ag/ZnO/NSP Nano-Composite

The water solutions of the ZnO/NSP nano-composite (w/w=15/85), the Ag/NSP nano-composite (w/w=1/99), the Ag/ZnO/NSP nano-composite (w/w/w=1/5/99) and the Ag/ZnO/NSP nano-composite (w/w/w=1/10/99) are brought to the antibacterial tests against E. coli and S. aureus. TABLE 3 shows the testing results.

TABLE 3

| | | MBC (ppm) | | | |
|---|---|---|---|---|---|
| Samples | Weight ratio | S. aureus | | E. coli | |
| ZnO/NSP | 15/85 | 650 | (ZnO) | 920 | (ZnO) |
| Ag/NSP | 1/99 | 15 | (Ag) | 1 | (Ag) |
| Ag/ZnO/NSP | 1/5/99 | 4 | (Ag) | 1 | (Ag) |
| Ag/ZnO/NSP | 1/10/99 | 4 | (Ag) | 1 | (Ag) |

TABLE 3 shows that the bactericidal efficacies of the Ag/NSP nano-composite are about quadrupled by adding ZnO nano-particles. That is, the amount of Ag can be decreased to one fourth.

### 6. Animal Testing

The livestock feed is modified by spray drying the ZnO/NSP nano-particles to mix with corn flour. Then the modified feed is supplied to livestock in small farms. The result shows that survivability of poultry increases by 20% and mortality of piglets decreases by 40% by inhibiting virus which causes porcine reproductive and respiratory syndrome (PRRS).

What is claimed is:

1. A metallic oxide/silicate clay nano-composite, comprising:
silicate clay selected from the group consisting of nanosilicate platelets (NSPs), montomorillonite (Na⁺-MMT), fluoro mica, K10, SWN, kaolin, talc, attapulgite and vermiculite, wherein the NSPs are fully exfoliated silicate clay, have a diameter-to-thickness ratio ranging from 100×100×1 nm³ to 500×500×1 nm³, and have a cation exchange capacity (CEC) ranging from 1.0 mequiv/g to 1.5 mequiv/g; and
metallic oxide nanoparticles selected from the group consisting of ZnO, Fe₃O₄, CuO, MgO, CaO and mixtures thereof, and uniformly dispersed and adsorbed on surfaces of the silicate clay by ionic bonds and Van der Waals forces;
wherein the metallic oxide nanoparticles and the silicate clay have a weight ratio ranging from 1/99 to 90/10.

2. The metallic oxide/silicate clay nano-composite of claim 1, wherein the silicate clay is the nanosilicate platelets (NSPs).

3. The metallic oxide/silicate clay nano-composite of claim 1, wherein the metallic oxide is ZnO or CuO.

4. The metallic oxide/silicate clay nano-composite of claim 1, wherein the metallic oxide nanoparticles and the silicate clay have a weight ratio ranging from 1/99 to 70/30.

5. The metallic oxide/silicate clay nano-composite of claim 1, further comprising:
silver nanoparticles stabilized on surfaces of the silicate clay by ionic bonds and Van der Waals forces.

6. The metallic oxide/silicate clay nano-composite of claim 5, wherein the silicate clay is the nanosilicate platelets (NSPs) and the metallic oxide is ZnO.

7. A method for producing a metallic oxide/silicate clay nano-composite, comprising steps of:
(1) adding a water solution of a metallic salt into a dispersion of silicate clay to perform an ion-exchange reaction, wherein the metallic salt contains at least one metallic ion selected from the group consisting of Zn, Fe, Cu, Mg and Ca, and the silicate clay is selected from the group consisting of nanosilicate platelets (NSPs), montomorillonite (Na⁺-MMT), fluoro mica, K10, SWN, kaolin, talc and attapulgite, wherein the NSPs are fully exfoliated silicate clay, have a diameter-to-thickness ratio ranging from 100×100×1 nm³ to 500×500×1 nm³ and a cation exchange capacity (CEC) ranging from 1.0 mequiv/g to 1.5 mequiv/g;
(2) adding a hydroxide to react with the metallic salt to form a metallic hydroxide on surfaces of the silicate clay; and
(3) dehydrogenating the metallic hydroxide at 40° C.-99° C. to form a metallic oxide stabilized on the surfaces of the silicate clay as a product, the metallic oxide/silicate clay nano-composite.

8. The method of claim 7, wherein the silicate clay of step (1) is nanosilicate platelets (NSPs).

9. The method of claim 7, wherein the metal of step (1) is Zn or Cu.

10. The method of claim 7, wherein the metallic salt of step (1) is a metallic acetate, a metallic carbonate or a metallic chloride.

11. The method of claim 7, wherein the ion-exchange reaction of step (1) is performed at 40° C.-99° C.

12. The method of claim 7, wherein the hydroxide of step (2) is NaOH or NH₄OH.

13. The method of claim 7, wherein the product of step (3) is further filtered to obtain the metallic oxide/silicate clay nano-composite in the form of powder.

14. The method of claim 7, further comprising a step:
(4) adding a compound of silver ions and a reducing agent to reduce the silver ions to silver nanoparticles stabilized on the surfaces of the silicate clay.

15. The method of claim 7, wherein the silicate clay is the nanosilicate platelets (NSPs) and the metal is Zn, and the method further comprises step (4) adding a compound of silver ions and a reducing agent to reduce the silver ions to silver nanoparticles stabilized on the surfaces of the silicate clay.

16. A modified livestock feed, comprising a livestock feed and a metallic oxide/silicate clay nano-composite attached to the livestock feed, wherein the metallic oxide/silicate clay nano-composite comprises:
silicate clay selected from the group of consisting of nanosilicate platelets (NSPs), montmorillonite (Na⁺-MMT), fluoro mica, K10, SWN, kaolin, talc, attapulgite and vermiculite, wherein the NSPs are fully exfoliated silicate clay, have a diameter-to-thickness ratio ranging from 100×100×1 nm³ to 500×500×1 nm³ and have a cation exchange capacity (CEC) ranging from 1.0 mequiv/g to 1.5 mequiv/g; and
metallic oxide nanoparticles selected from the group consisting of ZnO, CuO, Fe₃O₄, MgO and CaO and uniformly stabilized on surfaces of the silicate clay by ionic bonds and Van der Waals forces;
wherein the metallic oxide nanoparticles and the silicate clay have a weight ratio ranging from 1/99 to 90/10.

17. The modified livestock feed of claim 16, wherein the livestock feed is selected from the group consisting of modified starch, corn flour, sweet potato starch, water-soluble starch, high-fructose corn syrup (HFCS), mung bean starch, wheat starch, glucosan, soybean powder, cyclodextrin, maltodextrin, carboxymethyl cellulose (CMC), cellulose, gum Arabic, carrageenan, xanthan gum, alginate, trehalose, rice bran, gluten, corn bran and polyethylene glycol (PEG).

18. The modified feed of claim 16, wherein the silicate clay is nanosilicate platelets (NSPs).

19. The modified feed of claim 16, wherein the metallic oxide is ZnO or CuO.

20. The modified feed of claim 16, wherein the metallic oxide/silicate clay nano-composite is attached to the livestock feed by spray drying.
